(19) United States
(12) Patent Application Publication
(10) Pub. No.: US 2001/0013893 A1
(43) Pub. Date: Aug. 16, 2001

(54) Compatible camera system

(76) Inventor: Rudolf Pieter Koppe, Breda (NL)

Correspondence Address: Michael E. Marion, c/o U.S. PHILIPS CORPORATION, Intellectual Property Department, 580 White Plains Road, Tarrytown, NY, 10591, US

(21) Appl. No.: 09/745,958

(22) Filed: Dec. 21, 2000

(30) Foreign Application Priority Data
Dec. 23, 1999 (EP) 99204498.2

(51) Int. Cl. H04N 5/225

(52) U.S. Cl. 348/207; 348/211; 348/554

(57) ABSTRACT

Camera systems as known in the art have to determine before operation the type of base station and the type of camera.

The invention provides a compatible camera system whereby the base station detects the kind of camera that is operative.

The invention relates to a camera system as described in the preamble of claim 1.

Camera systems are known in the art and basically comprise a camera for gathering information such as news, sport events, etc. and a base station, for example a truck with a recording apparatus and for example communication means with a studio by satellite etc. The camera can be operated by a cameraman or being automatically operated from the base station. The camera is coupled to the base station by transmission means, for example the known triax cable.

At the moment there are basically two transmission systems it is the so-called RGB-system and the so-called Y, R-Y, B-Y-system. Until now most of the cameras are all operating according to the RGB system.

A disadvantage of the known cameras and known base stations is that a camera can only operate with a corresponding base station.

It is, inter alia, an object of the invention to provide a camera system that can operate with both kinds of cameras. To that end a camera system according to the invention has the features as described in claim 1. By adding a detection unit and a switching unit to the base station it is made possible to detect what kind of camera is coupled to the base station and switch over the base station to the corresponding transmission standard. The invention further relates to a base station for use in such a camera system. An embodiment of the invention comprises the features as claimed in claim 2.

A further embodiment of the invention comprises the features of claim 3. In this embodiment the camera transmits information which standard is used on the basis of the synchronization signal. Either a first mode with a so-called G signal with a horizontal sink signal or a second mode with an Y video with a composite synchronization signal.

The invention and additional features, which may be optimally used to implant the invention to advantage, will be apparent from and elucidated with reference to the examples described below hereinafter and shown in the figures.

Herein shows:

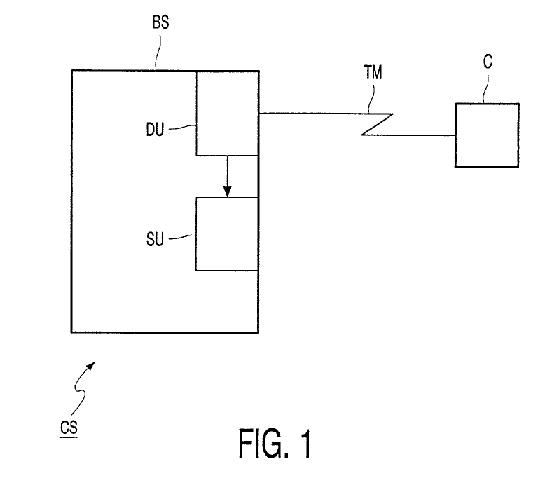

FIG. 1 schematically a camera system according to the invention, and

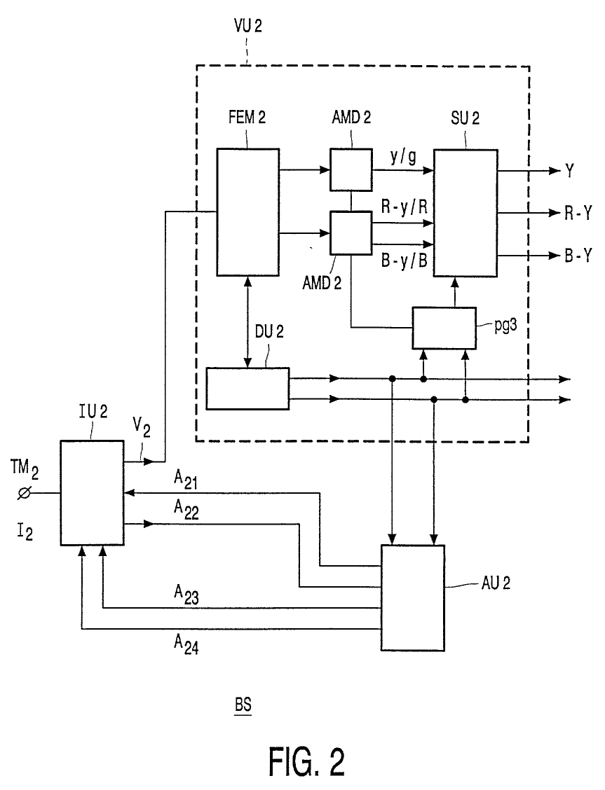

FIG. 2 a base station according to the invention in more detail.

FIG. 1 shows a camera system CS according to the invention comprising at least one camera C, transmission means TM and a base station BS. The camera is coupled via the transmission means to the base station, whereby the base station comprises a detection unit du for detecting the transmission mode. The detection unit du supplies a detection signal ds to a switching unit SU for switching over a part of the base station to the detected transmission mode. In FIG. 2 the base station will be described in more detail.

In this way it is made possible that the base station will operate with the different kind of cameras without the need to change the base station to the type of camera used. The switchover to the other mode will be then automatically by the base station.

FIG. 2 shows an example of a base station BS2 according to the invention in more detail. The base station comprises an input i2 coupled to the transmission means tm2. The input is coupled to an interface unit iu2 for interfacing the base station signals with the transmission means. In this interface unit filters etc. are used to filter out the different signals to be supplied to the different parts of the base station. One output of the interface unit supplies a video signal v2 to be handled in the video unit vu2. The video unit comprises a so-called front-end module FEM. This front-end module supplies a signal to an AM demodulator AMD2. At an output this AM demodulator supplies either the Y or G signal and supplies the signal to the switching unit su2 at an other output the front-end module fem2 supplies a signal to a QAM demodulator QAMD2 having two outputs for supplying at one output the either RY or R signal and at the other output the B-Y or B signal. Both signals are supplied to the switching unit su2. The switching unit su2 the three signals are supplied to a converting unit cu2 for converting the input signals into the signals Y, R-Y, B-Y. The switching unit 2 further comprises a pulse generator pg2. The pulse generator receives from a detection unit du2 a detection signal, which of the two modes is applicable. The detection unit is coupled to the front-end module fem2. The interface unit iu2 is further coupled to an audio unit au2 for supplying and receiving respectively different audio signals a21, a22, a23 and a24.

It will be noticed that the camera system according to the invention can amended without departing from the spirit of the invention.

1. Camera system comprising at least one camera for recording information, transmission means for transmission of the recorded information and base station for receiving the recorded information and handling this received information, characterized in that the base station comprises a detection unit for detecting which of at least two different transmitting modes is used by the camera and a switching unit for switching the base station in response to the detected transmission mode.

2. Camera system according to claim 1, characterized in that the detection unit detects between the RGB signals and the Y, R-Y, B-Y transmission mode.

3. Camera system according to claim 2, characterized in that the camera transmits information either with a transmission mode having a first mode with a G signal with H sink signal or a second mode with Y video with composite sink.

4. Base station for use in a camera system according to claim 1.

5. Camera for use in a camera system according to claim 1.
